(19) United States
(12) Patent Application Publication
(10) Pub. No.: US 2008/0038494 A1
(43) Pub. Date: Feb. 14, 2008

(54) AUTHENTICATING AND IDENTIFYING OBJECTS BY DETECTING MARKINGS THROUGH TURBID MATERIALS

(76) Inventors: John A. Midgley, San Carlos, CA (US); William M. Pfenninger, Fremont, CA (US)

Correspondence Address: COOLEY GODWARD KRONISH LLP;ATTN: Patent Group, Suite 1100, 777 - 6th Street, NW, Washington, DC, 20001, US

(21) Appl. No.: 11/688,711

(22) Filed: Mar. 20, 2007

Related U.S. Application Data
(60) Provisional application No. 60/784,560, filed on Mar. 21, 2006.

(51) Int. Cl. B32B 1/06; C09K 11/08

(52) U.S. Cl. 428/34.1; 252/301.4 F

(57) ABSTRACT

Described herein are techniques for authenticating and identifying objects by detecting markings through turbid materials. In one embodiment, a container includes a substrate having an outer surface and an inner surface and including a turbid material. The container also includes a marking adjacent to the inner surface and including a luminescent material that exhibits photoluminescence in response to incident light directed on the outer surface. The photoluminescence has a quantum efficiency of at least 20 percent and a peak emission wavelength in the near infrared range.

### CROSS-REFERENCE TO RELATED APPLICATION

This application claims the benefit of U.S. Provisional Application Ser. No. 60/784,560, filed on Mar. 21, 2006, the disclosure of which is incorporated herein by reference in its entirety.

### FIELD OF THE INVENTION

The invention relates generally to authenticating and identifying objects. More particularly, the invention relates to authenticating and identifying objects by detecting markings through turbid materials.

### BACKGROUND OF THE INVENTION

An object to be authenticated or identified is sometimes provided with a specific marking, which can be part of the object itself or can be coupled to the object. For example, a commonly used marking is a bar code, which includes an array of elements that encode information related to an object. These elements typically include bars and spaces, with bars of varying widths representing strings of binary ones, and spaces of varying widths representing strings of binary zeros. Bar codes are typically read by optical scanners, which are sometimes referred to as bar code readers.

While bar codes are useful for tracking locations or identities of objects, these markings have limited effectiveness in terms of preventing counterfeiting. In particular, to allow reading by a bar code reader, a bar code is typically printed on an outer surface of an object or a label that is coupled to the object. As such, the bar code is clearly visible and, thus, can be prone to reproduction or tampering. Moreover, the bar code can be prone to being degraded by dirt, surface scratches, or other damage.

It is against this background that a need arose to develop the apparatus, system, and method described herein.

### SUMMARY OF THE INVENTION

In one aspect, the invention relates to a container for an object. In one embodiment, the container includes a substrate having an outer surface and an inner surface and including a turbid material. The container also includes a marking adjacent to the inner surface and including a luminescent material that exhibits photoluminescence in response to incident light directed on the outer surface. The photoluminescence has a quantum efficiency of at least 20 percent and a peak emission wavelength in the near infrared range.

In another aspect, the invention relates to a label for an object. In one embodiment, the label includes a substrate and a coating adjacent to the substrate and including a set of luminescent materials to provide an optical signature. At least one of the set of luminescent materials has the formula:
[AₐB_{b}Xₓ],
wherein A is selected from elements of Group IA; B is selected from elements of Group VA, elements of Group IB, elements of Group IIB, elements of Group IIIB, elements of Group IVB, and elements of Group VB; X is selected from elements of Group VIIB; a is in the range of 1 to 9; b is in the range of 1 to 5; and x is in the range of 1 to 9.

Other aspects and embodiments of the invention are also contemplated. The foregoing summary and the following detailed description are not meant to restrict the invention to any particular embodiment but are merely meant to describe various embodiments of the invention.

### BRIEF DESCRIPTION OF THE DRAWINGS

For a better understanding of the nature and objects of some embodiments of the invention, reference should be made to the following detailed description taken in conjunction with the accompanying drawings.

FIG. 1 illustrates a security system that is implemented in accordance with an embodiment of the invention.

FIG. 2 illustrates spectral encoding that can be obtained by adjusting relative proportions of luminescent materials having different emission spectra, according to an embodiment of the invention.

### DETAILED DESCRIPTION

### Definitions

The following definitions apply to some of the elements described with regard to some embodiments of the invention. These definitions may likewise be expanded upon herein.

As used herein, the singular terms “a,” “an,” and “the” include plural referents unless the context clearly dictates otherwise. Thus, for example, reference to a luminescent material can include multiple luminescent materials unless the context clearly dictates otherwise.

As used herein, the term “set” refers to a collection of one or more elements. Thus, for example, a set of particles can include a single particle or multiple particles. Elements of a set can also be referred to as members of the set. Elements of a set can be the same or different. In some instances, elements of a set can share one or more common characteristics.

As used herein, the terms “optional” and “optionally” mean that the subsequently described event or circumstance may or may not occur and that the description includes instances where the event or circumstance occurs and instances in which it does not.

As used herein, the term “adjacent” refers to being near or adjoining. Objects that are adjacent can be spaced apart from one another or can be in actual or direct contact with one another. In some instances, objects that are adjacent can be coupled to one another or can be formed integrally with one another.

As used herein, the term “ultraviolet range” refers to a range of wavelengths from about 5 nanometer (“nm”) to about 400 nm.

As used herein, the term “visible range” refers to a range of wavelengths from about 400 mm to about 700 nm.

As used herein, the term “infrared range” refers to a range of wavelengths from about 700 nm to about 2 millimeter (“mm”). The infrared range includes the “near infrared range,” which refers to a range of wavelengths from about 700 nm to about 5 micrometer (“μm”), the “middle infrared range,” which refers to a range of wavelengths from about 5 μm to about 30 μm, and the “far infrared range,” which refers to a range of wavelengths from about 30 μm to about 2 mm.

As used herein, the terms “reflection,” “reflect,” and “reflective” refer to a bending or deflection of light. A bending or deflection of light can be substantially in a single direction, such as in the case of specular reflection, or can be in multiple directions, such as in the case of diffuse reflection or scattering. In general, light incident upon a material and light reflected from the material can have wavelengths that are the same or different.

As used herein, the terms “turbidity” and “turbid” refer to a scattering of light passing through a material. Typically, a turbid material can allow at least some light to pass through, albeit in a diffuse fashion as a result of scattering within the turbid material. As such, the turbid material can appear translucent or semi-opaque. A certain fraction of light incident upon a surface of a turbid material can penetrate the surface, and can be scattered within the turbid material before being absorbed or before exiting the turbid material. In some instances, light passing through the turbid material can be predominantly scattered rather than absorbed. Scattering within a turbid material can occur based on the presence of inhomogeneities, which serve as scattering entities that can alter a direction of propagation, a polarization, or a phase of light passing through the turbid material. In the case of a scattering entity that is substantially spherical, scattering within a turbid material can be referred to as being in the Rayleigh regime when a radius of the scattering entity is less than a wavelength of light. In this regime, an intensity of scattered light can be substantially equal in both forward and backward directions. As the radius of the scattering entity increases, scattering can become more peaked in the forward direction. Once the radius of the scattering entity is greater than the wavelength of light, scattering can be referred to as being in the Mie regime, and can become peaked at certain discrete angles. In some instances, propagation of light through a turbid material can be envisioned with respect to a set of photons passing through the turbid material. Typically, a photon can undergo multiple scattering events before being absorbed or before exiting a turbid material, such as at least 3 scattering events. A turbid material can be characterized by a scattering mean free path λₛ, which refers to an average distance that a photon travels before being scattered, and a transport mean free path λₜ, which refers to an average distance that a photon travels before a direction of propagation of light is substantially randomized. λₜ can depend upon a number of factors, including a wavelength of light, a concentration of scattering entities, a refractive index contrast between the scattering entities and a surrounding medium, and an anisotropy factor related to a directional distribution of scattering. In some instances, λₜ can increase as the wavelength of light increases. Typically, λₜ can be greater than λₛ, and can have values in the range of about 1 mm to about 2 mm for scattering of light in the infrared range.

As used herein, the terms “luminescence,” “luminesce,” and “luminescent” refer to an emission of light in response to an energy excitation. Luminescence can occur based on relaxation from excited electronic states of atoms or molecules and can include, for example, chemiluminescence, electroluminescence, photoluminescence, thermoluminescence, triboluminescence, and combinations thereof. For example, in the case of electroluminescence, an excited electronic state can be produced based on an electrical excitation. In the case of photoluminescence, which can include fluorescence and phosphorescence, an excited electronic state can be produced based on an optical excitation, such as absorption of light. In general, light incident upon a material and light emitted by the material can have wavelengths that are the same or different.

As used herein with respect to photoluminescence, the term “quantum efficiency” refers to a ratio of the number of photons emitted by a material to the number of photons absorbed by the material.

As used herein, the term “absorption spectrum” refers to a representation of absorption of light over a range of wavelengths. In some instances, an absorption spectrum can refer to a plot of absorbance (or transmittance) of a material as a function of wavelength of light incident upon the material.

As used herein, the term “emission spectrum” refers to a representation of emission of light over a range of wavelengths. In some instances, an emission spectrum can refer to a plot of intensity of light emitted by a material as a function of wavelength of the emitted light.

As used herein, the term “Full Width at Half Maximum” or “FWHM” refers to a measure of spectral width. In the case of an emission spectrum, a FWHM can refer to a width of the emission spectrum at half of a peak intensity value.

As used herein, the term “sub-nanometer range” or “sub-nm range” refers to a range of dimensions less than about 1 nm, such as from about 0.1 nm to slightly less than about 1 nm.

As used herein, the term “nanometer range” or “nm range” refers to a range of dimensions from about 1 nm to about 1 μm. The nm range includes the “lower nm range,” which refers to a range of dimensions from about 1 nm to about 10 nm, the “middle run range,” which refers to a range of dimensions from about 10 nm to about 100 nm, and the “upper nm range,” which refers to a range of dimensions from about 100 nm to about 1 μm.

As used herein, the term “micrometer range” or “am range” refers to a range of dimensions from about 1 μm to about 1 mm. The μm range includes the “lower Jim range,” which refers to a range of dimensions from about 1 μm to about 10 μm, the “middle Elm range,” which refers to a range of dimensions from about 10 μm to about 100 μm, and the “upper μm range,” which refers to a range of dimensions from about 100 μm to about 1 mm.

As used herein, the term “size” refers to a characteristic dimension of an object. In the case of a particle that is spherical, a size of the particle can refer to a diameter of the particle. In the case of a particle that is non-spherical, a size of the particle can refer to an average of various orthogonal dimensions of the particle. Thus, for example, a size of a particle that is a spheroidal can refer to an average of a major axis and a minor axis of the particle. When referring to a set of particles as having a specific size, it is contemplated that the particles can have a distribution of sizes around that size. Thus, as used herein, a size of a set of particles can refer to a typical size of a distribution of sizes, such as an average size, a median size, or a peak size.

As used herein, the term “monodisperse” refers to being substantially uniform with respect to a set of characteristics. Thus, for example, a set of particles that are monodisperse can refer to such particles that have a narrow distribution of sizes around a typical size of the distribution of sizes. In some instances, a set of particles that are monodisperse can have sizes exhibiting a standard deviation of less than 20 percent with respect to an average size, such as less than 10 percent or less than 5 percent.

As used herein, the term “monolayer” refers to a single complete coating of a material with no additional material added beyond the complete coating.

As used herein, the term “dopant” refers to a chemical entity that is present in a material as an additive or an impurity. In some instances, the presence of a dopant in a material can alter a set of characteristics of the material, such as its chemical, magnetic, electronic, or optical characteristics.

As used herein, the term “electron acceptor” refers to a chemical entity that has a tendency to attract an electron from another chemical entity, while the term “electron donor” refers to a chemical entity that has a tendency to provide an electron to another chemical entity. In some instances, an electron acceptor can have a tendency to attract an electron from an electron donor. It should be recognized that electron attracting and electron providing characteristics of a chemical entity are relative. In particular, a chemical entity that serves as an electron acceptor in one instance can serve as an electron donor in another instance. Examples of electron acceptors include positively charged chemical entities and chemical entities including atoms with relatively high electronegativities. Examples of electron donors include negatively charged chemical entities and chemical entities including atoms with relatively low electronegativities.

As used herein, the term “nanoparticle” refers to a particle that has a size in the nm range. A nanoparticle can have any of a variety of shapes, such as box-shaped, cube-shaped, cylindrical, disk-shaped, spherical, spheroidal, tetrahedral, tripodal, tube-shaped, pyramid-shaped, or any other regular or irregular shape, and can be formed of any of a variety of materials. In some instances, a nanoparticle can include a core formed of a first material, which core can be optionally surrounded by an outer layer formed of a second material. The first material and the second material can be the same or different. Depending on the configuration of a nanoparticle, the nanoparticle can exhibit size dependent characteristics associated with quantum confinement. However, it is also contemplated that a nanoparticle can substantially lack size dependent characteristics associated with quantum confinement or can exhibit such size dependent characteristics to a low degree.

As used herein, the term “surface ligand” refers to a chemical entity that can be used to form an outer layer of a particle, such as a nanoparticle. A surface ligand can have an affinity for or can be chemically bonded, either covalently or non-covalently, to a core of a nanoparticle. In some instances, a surface ligand can be chemically bonded to a core at multiple portions along the surface ligand. A surface ligand can optionally include a set of active portions that do not interact specifically with a core. A surface ligand can be substantially hydrophilic, substantially hydrophobic, or substantially amphiphilic. Examples of surface ligands include organic molecules, such as hydroquinone, ascorbic acid, silanes, and siloxanes; polymers (or monomers for a polymerization reaction), such as polyvinylphenol; and inorganic complexes. Additional examples of surface ligands include chemical groups, such alkyl groups, alkenyl groups, alkynyl groups, aryl groups, iminyl groups, hydride groups, halo groups, hydroxy groups, alkoxy groups, alkenoxy groups, alkynoxy groups, aryloxy groups, carboxy groups, alkylcarbonyloxy groups, alkenylcarbonyloxy groups, alkynylcarbonyloxy groups, arylcarbonyloxy groups, thio groups, alkylthio groups, alkenylthio groups, alkynylthio groups, arylthio groups, cyano groups, nitro groups, amino groups, N-substituted amino groups, alkylcarbonylamino groups, N-substituted alkylcarbonylamino groups, alkenylcarbonylamino groups, N-substituted alkenylcarbonylamino groups, alkynylcarbonylamino groups, N-substituted alkynylcarbonylamino groups, arylcarbonylamino groups, N-substituted arylcarbonylamino groups, silyl groups, and siloxy groups.

### Overview

Embodiments of the invention relate to the use of luminescent materials to form markings for objects. The markings can serve as security markings and, thus, can be advantageously used in anti-counterfeiting applications. For example, the markings can be used to verify whether objects bearing those markings are authentic or original. Alternatively, or in conjunction, the markings can serve as identification markings and, thus, can be advantageously used in inventory applications. For example, the markings can be used to track identities or locations of objects bearing those markings as part of inventory control. The markings can be used in place of, or in conjunction with, standard markings, such as bar codes, holograms, and radio frequency identification tags, thereby providing an improved level of security or identification.

Advantageously, the use of luminescent materials can allow markings to be formed in an inconspicuous fashion, such that the markings can serve as covert markings that are not readily detectable without a suitable optical detector. In some instances, the markings can be covered by or incorporated within turbid materials, such as those used to form containers, packagings, and labels. For example, a marking can be positioned within a container that encloses an object to be authenticated or identified, or can be positioned on the unexposed side of a label that is coupled to the object. In such fashion, the presence of the marking can be relatively unnoticeable, and, thus, the marking can be less prone to reproduction or tampering. Moreover, the marking can be less prone to being degraded by dirt, surface scratches, or other damage. During use, a suitable optical detector can detect the marking through the container or through the label. In such fashion, the object can be authenticated or identified without opening the container or lifting the label.

### Security System

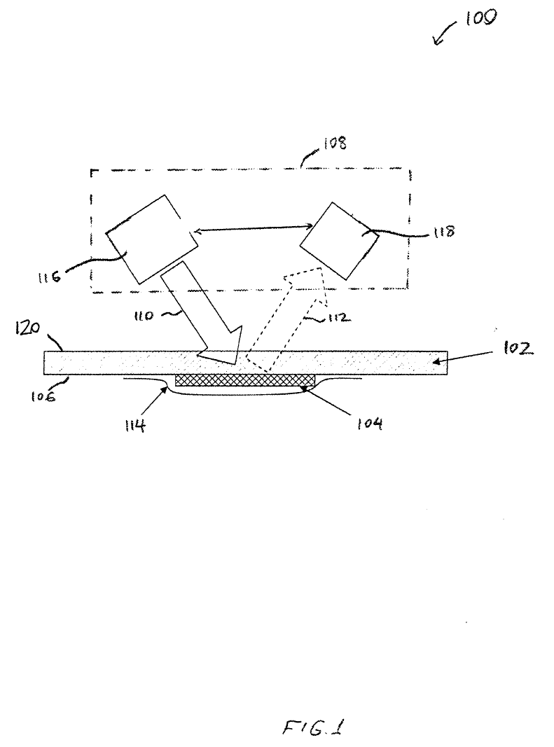

FIG. 1 illustrates a system 100 that is implemented in accordance with an embodiment of the invention. As further described below, the system 100 is operated as a security system to prevent or reduce counterfeiting of objects, such as consumer products, credit cards, currency, identification cards, passports, and pharmaceuticals. However, it is also contemplated that the system 100 can be operated as an inventory system to track identities or locations of those objects as part of inventory control.

As illustrated in FIG. 1, the system 100 includes a substrate 102, which forms a portion of an object of interest or another object that is coupled to or encloses the object of interest. The substrate 102 has an outer surface 120, which faces an outside environment, and an inner surface 106, which faces away from the outside environment. For example, the substrate 102 can form a portion of a container or a packaging, such as a blister pack or a bottle, and can define an internal compartment that is sized to accommodate the object of interest. In this example, the inner surface 106 faces the internal compartment that accommodates the object of interest. As another example, the substrate 102 can form a portion of a label or another display element, which can be affixed or coupled to the object of interest using any suitable fastening mechanism, such as using an adhesive. In this example, the inner surface 106 faces the object of interest when the label is coupled to that object. The substrate 102 is formed of any suitable material, such as one typically used to form a container, a packaging, or a label. As can be appreciated, certain materials used to form containers, packagings, and labels can allow at least some amount of light to pass through, albeit in a diffuse fashion as a result of scattering within the materials, and, thus, can be referred to as turbid materials. Examples of turbid materials include fibrous materials, glasses, polymers, and a variety of other non-metallic materials. Thus, for example, the substrate 102 can be a fabric formed of natural or synthetic fibers (e.g., a woven fabric or a non-woven fabric), a film formed of a plastic, a leather, a cardboard, or a piece of paper. While not illustrated in FIG. 1, it is contemplated that the substrate 102 can be formed so as to include two or more sub-layers, which can be formed of the same material or different materials.

Referring to FIG. 1, the system 100 also includes a marking 104, which is formed adjacent to the inner surface 106 of the substrate 102 using any suitable coating or printing technique. Depending on characteristics of the substrate 102 or a particular coating or printing technique that is used, the marking 104 can extend beyond the inner surface 106 of the substrate 102 and at least partly permeate the substrate 102. During use, the marking 104 is positioned so that it is facing away from the outside environment, thus serving as a covert marking. Thus, for example, the marking 104 can be positioned so that it is adjacent to an internal compartment of a container or a packaging that encloses the object of interest. As another example, the marking 104 can be positioned so that it is on the unexposed side of a label that is coupled to the object of interest. In such fashion, the presence of the marking 104 can be relatively unnoticeable, and, thus, the marking 104 can be less prone to reproduction or tampering. Moreover, the marking 104 can be less prone to being degraded by dirt, surface scratches, or other damage. However, it is also contemplated that the marking 104 can be positioned so that it is exposed to the outside environment.

In the illustrated embodiment, the marking 104 is formed of a set of luminescent materials, and emission of light upon suitable energy excitation provides a set of optical signatures. Unlike a standard marking, such as a bar code, the set of optical signatures provided by the marking 104 is not readily reproduced or mimicked, and, thus, the marking 104 can be advantageously used in anti-counterfeiting applications. Thus, for example, the marking 104 can be formed of a luminescent material that exhibits photoluminescence, and emission of light upon irradiation can provide a specific optical signature that can be used to verify whether the object of interest is authentic or original. While not illustrated in FIG. 1, it is contemplated that the marking 104 can be formed so as to include two or more sub-layers, which can be formed of the same luminescent material or different luminescent materials. It is also contemplated that a set of luminescent materials forming the marking 104 can be included within the substrate 102.

As illustrated in FIG. 1, the system 100 also includes an optical detector 108, which is used to detect the set of optical signatures provided by the marking 104. Advantageously, the optical detector 108 is implemented to read the marking 104 through the substrate 102, which, as described above, can form a portion of a container, a packaging, or a label. In such fashion, the object of interest can be authenticated or identified without opening the container or the packaging or without lifting the label.

During use, the optical detector 108 produces incident light 110, which is directed towards the outer surface 120 of the substrate 102. A certain fraction of the incident light 110 passes through the substrate 102 to reach the marking 104, which produces emitted light 112 in response to that optical excitation. A certain fraction of the emitted light 112 passes through the substrate 102 to reach the optical detector 108, which detects the set of optical signatures based on characteristics of the emitted light 112. To provide improved detection sensitivity, the system 100 desirably includes a reflective element 114, which is positioned adjacent to the marking 104 to reflect a certain fraction of the emitted light 112 back towards the outer surface 120 and towards the optical detector 108. In such fashion, the reflective element 114 can provide a higher relative intensity for the emitted light 112 and an improved signal-to-noise ratio with respect to the incident light 110 or other background noise. In the illustrated embodiment, the reflective element 114 is formed as a reflective backing or a reflective covering, and is coupled to either of, or both, the substrate 102 and the marking 104 using any suitable fastening mechanism, such as using an adhesive. The reflective element 114 is formed of any suitable reflective material, such as a metal. Thus, for example, the reflective element 114 can be a foil formed of a metal. While not illustrated in FIG. 1, it is contemplated that the reflective element 114 can be formed so as to include two or more sub-layers, which can be formed of the same material or different materials. For certain implementations, at least one of the sub-layers can be formed of a metal, such as in the form of a coating of the metal. Thus, for example, the reflective element 114 can be a plastic film that is at least partially covered by a coating of a metal.

As illustrated in FIG. 1, the optical detector 108 includes a light source 116 and a reader 118 that is coupled to the light source 116. The optical detector 108 can be implemented in a variety of ways. In some instances, a portable computing device can be used as the optical detector 108. Examples of portable computing devices include laptop computers, palm-sized computers, tablet computers, personal digital assistants, cameras, and cellular telephones.

Depending on characteristics of the substrate 102 and the marking 104, the light source 116 can produce the incident light 110 so as to have a set of wavelengths in the ultraviolet range, the visible range, the infrared range, or a combination thereof. In some instances, the set of wavelengths of the incident light 110 can be matched with an absorption spectrum of a luminescent material forming the marking 104. For a combination of luminescent materials having different absorption spectra, the incident light 110 can have multiple sets of wavelengths that are matched with the different absorption spectra. The incident light 110 can be collimated or quasi-collimated, such as produced by a laser or focused by a lens, and the degree of collimation can affect luminescent and scattering characteristics. In some instances, the incident light 110 can be modulated, such as in accordance with an amplitude modulation scheme or a frequency modulation scheme, and such modulation can be used to provide improved detection sensitivity.

Examples of the light source 116 include incandescent light sources, light emitting diodes, lasers, sunlight, and ambient light sources. In some instances, a laser can be desirable, since it can provide coherent light that can be used for phase sensitive detection, which can allow improved detection sensitivity. In other instances, a color video monitor, a computer monitor screen, or other color display screen, such as of a cellular telephone phone, can be used as the light source 116. In yet other instances, a flash unit, such as of a camera or a cellular telephone phone equipped with a camera, can be used as the light source 116.

The reader 118 can be implemented in a variety of ways, such as using a set of photo-detectors, such as a set of silicon-based photo-detectors or gallium arsenide-based photo-detectors; an imager, such as a multi-dimensional imager; a charge-coupled device, such as one included in a digital camera; or a combination thereof. Thus, for example, the reader 118 can include a photo-detector, and a sensitivity of the photo-detector can be matched with an emission spectrum of a luminescent material forming the marking 104. For a combination of luminescent materials having different emission spectra, the reader 118 can include distinct photo-detectors that are matched with the different emission spectra.

While not illustrated in FIG. 1, it is contemplated that the optical detector 108 can also include a set of optical elements, which can be positioned between the marking 104 and either of, or both, the light source 116 and the reader 118. Examples of suitable optical elements include lenses, apertures, optical filters, polarizers, spectrometers, and combinations thereof. In some instances, an optical filter can be used to select the emitted light 112 or to remove contributions from the incident light 110 or other background noise. The optical filter can be a short wavelength cutoff filter, a long wavelength cutoff filter, or a notch filter. In the case of a laser that provides coherent light, phase sensitive detection can be used along with a suitable modulation scheme to provide improved detection sensitivity, such as using lock-in amplification. In this case, the optical detector 108 can include a set of optical elements to provide a split optical path.

### Markings for Anti-Counterfeiting and Inventory Applications

For some embodiments of the invention, a marking can encode a set of signatures that can be used for authentication purposes, identification purposes, or both. In some instances, the marking can encode multiple signatures that provide multiple levels of security or identification. Each signature can be used independently of other signatures, and, in some instances, certain signatures can be omitted or skipped for a reduced level of security, a reduced cost, or a reduced processing time. It is also contemplated that a signature providing a lower level of security can be used to reduce a search space for another signature providing a higher level of security.

For example, a marking can be formed of a luminescent material that exhibits photoluminescence, and emission of light upon irradiation can provide a specific optical signature for an initial level of security. In particular, the presence or absence of emitted light within a particular range of wavelengths can be used to verify whether an object bearing the marking is authentic or original. Detection of the emitted light can be performed using an optical detector that includes a reader sensitive to the emitted light, and that also includes an optical filter or spectrometer to select the emitted light. Once selected, a comparison of an intensity of the emitted light with respect to a threshold intensity value can be performed to detect the emitted light. Here, the emitted light and incident light can have wavelengths that are different. Thus, for example, the luminescent material can emit light at longer wavelengths, or lower energies, than the incident light. However, it is also contemplated that the luminescent material can emit light at shorter wavelengths, or higher energies, than the incident light. In the event that the emitted light is in the visible range, the marking can appear colored when irradiated. On the other hand, in the event that the emitted light is in the ultraviolet range or the infrared range, the marking can remain colorless or can retain its original color when irradiated.

As another example, a marking can be formed so as to have a combination of different absorption spectra or different emission spectra, and the different absorption spectra or different emission spectra can provide a specific optical signature for an additional level of security. In some instances, the marking can be formed so as to include a mixture of luminescent materials that differ in their photoluminescent characteristics. In particular, the luminescent materials can have different elemental compositions or different concentrations or types of dopants.

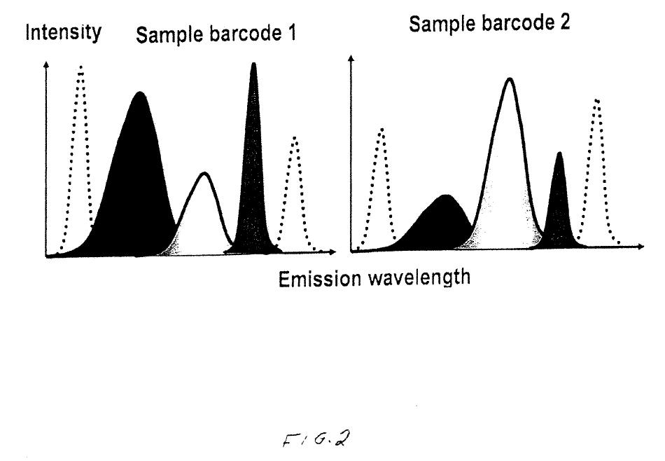

FIG. 2 illustrates spectral encoding that can be obtained by adjusting relative proportions of luminescent materials having different emission spectra, according to an embodiment of the invention. As illustrated in FIG. 2, the different emission spectra can provide multiple “colors” with respective intensities that can be tuned to desired levels. Detection of these multiple “colors” can be performed sequentially or simultaneously using an optical detector that operates in accordance with a multi-spectral technique. In particular, the optical detector can include distinct light sources to allow irradiation at different wavelengths and distinct optical filters to select emitted light at different wavelengths. A common reader can sometimes be used for all wavelengths. Alternatively, distinct readers that are sensitive to emitted light at different wavelengths can be used.

In other instances, the marking can be formed so as to include multiple layers of luminescent materials that differ in their photoluminescent characteristics. For example, a first layer can be formed adjacent to a substrate, and can include a first luminescent material that absorbs and emits light within a first range of wavelengths, while a second layer can be formed adjacent to the first layer, and can include a second luminescent material that absorbs and emits light within a second range of wavelengths. As described above, detection of emitted light from the two layers can be performed sequentially or simultaneously using an optical detector that operates in accordance with a multi-spectral technique. Alternatively, or in conjunction, an optical gating technique can be used if the two layers are spaced apart by a distance comparable to a photon transit time through the substrate. In particular, each of the two layers can be individually detected by gating a light source and a reader in a suitable manner, such as by using pulses from about 10 to about 20 picoseconds for a distance between the two layers of about 20 μm.

As a further example, a marking can be formed in a spatial pattern, such as a bar code, a numeric, a logo, or a text, and a distribution of a set of luminescent materials within the spatial pattern can provide a specific optical signature for a further level of security. In some instances, the marking can be formed of a luminescent material that exhibits photoluminescence, and emission of light upon irradiation can provide a specific photoluminescence pattern. In particular, the luminescent material can be distributed substantially uniformly within the spatial pattern, and the photoluminescence pattern can correspond to, or can be used to derive, the spatial pattern. In other instances, different portions of the marking can be formed from respective luminescent materials that differ in their photoluminescent characteristics. Thus, for example, each bar of a bar code can be formed so as to have a different emission spectrum. In such manner, the marking can be formed so as to provide a specific photoluminescence pattern having multiple “colors.” Detection of a photoluminescent pattern can be performed using an optical detector that operates in accordance with a suitable imaging technique, such as scanned imaging, time-resolved tomographic imaging, or optical coherence tomographic imaging. In the case that the marking is formed as a thin coating or film, such as one that is about 10 μm or less in thickness, the marking can be effectively viewed in two dimensions within a single optical plane. In the case of a thicker coating or film, the marking can be viewed as a three-dimensional photoluminescence pattern within multiple optical planes. In this case, a resulting image of the marking an depend on a viewing angle of the optical detector. If desired, the marking can be viewed from multiple directions and angles, resulting in different images.

### Formation of Markings

A variety of methods can be used to form the markings described herein. In some instances, a coating, ink, or varnish composition can be formed so as to include a set of particles dispersed therein, and the particles can be formed of a luminescent material to encode a set of signatures for authentication purposes, identification purposes, or both. The particles can have a single size or multiple sizes. Since photoluminescent characteristics of the particles can be size dependent, the use of multiple sizes can lead to multiple “colors.” The composition can include the particles as pigments along with one or more of the following ingredients: a solvent, a dispersant, a wetting agent (e.g., a surfactant, such as sodium dodecyl sulfate, a polymeric surfactant, or any other suitable ionic or non-ionic surfactant), a polymer binder (or other vehicle), an anti-foaming agent, a preservative, a stabilizer, and a pH adjusting agent. To achieve higher levels of security, the composition can also include a set of inert masking agents that provide a mixed compositional signature when performing chemical analysis. Also, the composition can include a relatively low concentration of the particles (e.g., a few micrograms per marking), thus rendering chemical analysis difficult. Next, a coating or printing technique can be used to apply the composition on an object of interest (or another object that is coupled to or encloses the object of interest), which serves as a substrate. Thus, for example, the composition can be applied using a standard coating technique, such as roller coating or spray coating, or using a standard printing technique, such as ink jet printing, offset printing, gravure printing, flexography printing, intaglio printing, or screen printing. Depending on characteristics of the substrate or a particular coating or printing technique that is used, the composition can permeate at least a portion of the substrate.

It is also contemplated that a marking can be formed by incorporating a set of particles within an object of interest or within another object that is coupled to or encloses the object of interest. Thus, for example, the particles can be formed of a luminescent material, and can be incorporated during formation of the object of interest, rather than deposited afterwards. In particular, a matrix material including the particles can be cast or extruded into a fiber, a film, a slab, or any other shape. The matrix material can be any of a variety of materials, including the turbid materials described above.

### Luminescent Materials

A variety of luminescent materials can be used to form the markings described herein. Particularly desirable luminescent materials include those exhibiting a combination of photoluminescent characteristics, such as those related to quantum efficiency, spectral width, spectral separation, absorption wavelengths, and emission wavelengths.

In particular, luminescent materials according to some embodiments of the invention can exhibit photoluminescence with a high quantum efficiency, thereby facilitating detection or imaging of the luminescent materials upon irradiation. In some instances, the quantum efficiency can be greater than about 6 percent, such as at least about 10 percent, at least about 20 percent, at least about 30 percent, at least about 40 percent, or at least about 50 percent, and can be up to about 90 percent or more. As can be appreciated, a high quantum efficiency can translate into a higher relative intensity for emitted light and an improved signal-to-noise ratio with respect to incident light or other background noise.

Also, the luminescent materials can exhibit photoluminescence with a narrow spectral width and a large spectral separation, thereby further facilitating detection or imaging of the luminescent materials upon irradiation. In some instances, the spectral width can be no greater than about 120 nm at FWHM, such as no greater than about 100 nm, no greater than about 80 nm, or no greater than about 50 nm at FWHM. Thus, for example, the spectral width can be in the range of about 50 nm to about 120 nm at FWHM, such as from about 50 nm to about 100 nm or from about 50 nm to about 80 nm at FWHM. As another example, the spectral width can be in the range of about 10 nm to about 50 nm at FWHM, such as from about 10 nm to about 40 nm, from about 10 nm to about 30 nm, or from about 10 nm to about 20 nm at FWHM. As can be appreciated, a narrow spectral width can translate into an improved resolution for emitted light with respect to incident light or other background noise. However, it is also contemplated that the spectral width can be greater than about 120 nm at FWHM, such as about 250 nm at FWHM for certain luminescent materials. For a given spectral width, an insufficient spectral separation between absorption wavelengths and emission wavelengths can sometimes lead to an undesirable signal-to-noise ratio with respect to incident light or other background noise. Thus, it can also be desirable that the luminescent materials have an adequate spectral separation, such that, for example, a peak absorption wavelength and a peak emission wavelength can be spaced apart by at least about 100 nm, such as at least about 150 nm or at least about 200 nm.

In addition, the luminescent materials can exhibit photoluminescence with absorption wavelengths and emission wavelengths that are located within desirable ranges of wavelengths. In some instances, either of, or both, the absorption wavelengths and the emission wavelengths can be located in the visible range or the infrared range, such as from about 700 nm to about 1.8 μm. Thus, for example, a peak emission wavelength can be located in the near infrared range, such as from about 900 nm to about 1 μm, from about 910 nm to about 1 μm, from about 910 nm to about 980 μm, or from about 930 nm to about 980 nm. As another example, the peak emission wavelength can be located in the range of about 700 nm to about 800 nm, such as from about 700 nm to about 750 nm or from about 700 μm to about 715 nm. However, it is also contemplated that the peak emission wavelength can be located in the middle infrared range, the far infrared range, the ultraviolet range, or the visible range. As can be appreciated, absorption and emission of light by a luminescent material at relatively long wavelengths can be particularly desirable for applications involving propagation of light through a turbid material. In particular, absorption of light by the luminescent material at relatively long wavelengths can allow the use of a light source that emit light at those wavelengths. Since absorption and scattering of light within the turbid material can be reduced for longer wavelengths, a higher fraction of incident light can pass through the turbid material to reach the luminescent material, which can emit light at relatively long wavelengths in response to that optical excitation. Again, since absorption and scattering of light within the turbid material can be reduced for longer wavelengths, a higher fraction of emitted light can pass through the turbid material to reach a reader, thereby providing a higher relative intensity for the emitted light and an improved signal-to-noise ratio with respect to the incident light or other background noise. Also, emission of light in the infrared range is not visible and, thus, can be advantageously exploited to form covert markings for anti-counterfeiting applications.

Examples of luminescent materials include those formed via a conversion of a set of ingredients into the luminescent materials at high yields and at moderate temperatures and pressures. The conversion can be represented with reference to the formula:
Source(B)+Source(A,X)→Luminescent Material (I)

In formula (I), source (B) serves as a source of B, and, in some instances, source (B) can also serve as a source of dopants. B can be selected from elements having suitable oxidation states, such that their ground electronic states include filled s orbitals and can be represented as (ns)². Examples of B include elements of Group VA, such as vanadium (e.g., as V(III) or V+³); elements of Group IB, such as copper (e.g., as Cu(I) or Cu⁺¹), silver (e.g., as Ag(I) or Ag⁺¹), and gold (e.g., as Au(I) or Au⁺¹); elements of Group IIB, such as zinc (e.g., as Zn(II) or Zn⁺²), cadmium (e.g., as Cd(II) or Cd⁺²), and mercury (e.g., as Hg(II) or Hg⁺²); elements of Group IIIB, such as gallium (e.g., as Ga(I) or Ga⁺¹), indium (e.g., as In(I) or In⁺¹), and thallium (e.g., as Tl(I) or Tl⁺¹); elements of Group IVB, such as germanium (e.g., as Ge(II) or Ge⁺² or as Ge(IV) or Ge⁺⁴), tin (e.g., as Sn(II) or Sn⁺² or as Sn(IV) or Sn⁺⁴), and lead (e.g., as Pb(II) or Pb⁺² or as Pb(IV) or Pb⁺⁴); and elements of Group VB, such as bismuth (e.g., as Bi(III) or Bi⁺³).

In the case that B is tin, for example, source (B) can include one or more types of tin-containing compounds selected from tin(II) compounds of the form BY, BY₂, B₃Y₂, and B₂Y and tin (IV) compounds of the form BY₄, where Y can be selected from elements of Group VIB, such as oxygen (e.g., as O⁻²); elements of Group VIIB, such as fluorine (e.g., as F⁻¹), chlorine (e.g., as Cl⁻¹), bromine (e.g., as Br⁻¹), and iodine (e.g., as I⁻¹); and poly-elemental chemical entities, such as nitrate (i.e., NO₃⁻¹), thiocyanate (i.e., SCN⁻¹), hypochlorite (i.e., OCl⁻), sulfate (i.e., SO₄⁻²), orthophosphate (i.e., PO₄⁻³), metaphosphate (i.e., PO₃⁻¹), oxalate (i.e., C₂O₄⁻²), methanesulfonate (i.e., CH₃SO₃⁻¹), trifluoromethanesulfonate (i.e., CF₃SO₃⁻¹), and pyrophosphate (i.e., P₂O₇⁻⁴). Examples of tin(II) compounds include tin(II) fluoride (i.e., SnF₂), tin(II) chloride (i.e., SnCl₂), tin(II) chloride dihydrate (i.e., SnCl₂.2H₂O), tin(II) bromide (i.e., SnBr₂), tin(II) iodide (i.e., SnI₂), tin(II) oxide (i.e., SnO), tin(II) sulfate (i.e., SnSO₄), tin(II) orthophosphate (i.e., Sn₃(PO₄)₂), tin(II) metaphosphate (i.e., Sn(PO₃)₂), tin(II) oxalate (i.e., Sn(C₂O₄)), tin(II) methanesulfonate (i.e., Sn(CH₃SO₃)₂), tin(II) pyrophosphate (i.e., Sn₂P₂O₇), and tin(II) trifluoromethanesulfonate (i.e., Sn(CF₃SO₃)₂). Examples of tin (IV) compounds include tin(IV) chloride (i.e., SnCl₄) and tin(IV) chloride pentahydrate (i.e., SnCl₄.5H₂O).

In formula (I), source (A, X) serves as a source of A and X, and, in some instances, source (A, X) can also serve as a source of dopants. A is a metal that can be selected from elements of Group IA, such as sodium (e.g., as Na(I) or Na¹⁺), potassium (e.g., as K(I) or K¹⁺), rubidium (e.g., as Rb(I) or Rb¹⁺), and cesium (e.g., as Cs(I) or Cs¹⁺), while X can be selected from elements of Group VIIB, such as fluorine (e.g., as F⁻¹), chlorine (e.g., as Cl⁻¹), bromine (e.g., as Br⁻¹), and iodine (e.g., as I⁻¹). Examples of source (A, X) include alkali halides of the form AX. In the case that A is cesium, for example, source (A, A) can include one or more types of cesium(I) halides, such as cesium(I) fluoride (i.e., CsF), cesium(I) chloride (i.e., CsCl), cesium(I) bromide (i.e., CsBr), and cesium(I) iodide (i.e., CsI).

The conversion represented by formula (I) can be performed by mixing source (B) and source (A, X) in a dry form, in solution, or in accordance with any other suitable mixing technique. It is also contemplated that a vacuum deposition technique can be used in place of, or in conjunction with, a mixing technique. For example, source (B) and source (A, X) can be provided in a powdered form, and can be mixed using a mortar and a pestle. As another example, source (B) and source (A, X) can be dispersed in a reaction medium to form a reaction mixture. The reaction medium can include a solvent or a mixture of solvents, which can be selected from a variety of standard solvents. In some instances, the conversion of source (B) and source (A, X) into a luminescent material can be facilitated by applying a form of energy, such as acoustic or vibrational energy, electrical energy, magnetic energy, mechanical energy, optical energy, or thermal energy. It is also contemplated that multiple forms of energy can be applied simultaneously or sequentially. For example, source (B) and source (A, A) can be mixed in a dry form, and the resulting mixture can be pressed to a pressure in the range of about 1×10⁵ Pascal to about 7×10⁸ Pascal, such as using a standard pellet press or a standard steel die, to form the luminescent material in a pellet form. As another example, source (B) and source (A, A) can be mixed in a dry form, and the resulting mixture can be heated to a temperature in the range of about 50° C. to about 650° C., such as from about 80° C. to about 350° C. or from about 80° C. to about 300° C., to form the luminescent material. If desired, heating can be performed in an inert atmosphere (e.g., a nitrogen atmosphere) or a reducing atmosphere for a time period in the range of about 0.5 hour to about 9 hours.

In formula (I), the resulting luminescent material can include A, B, and X as major elemental components as well as elemental components derived from or corresponding to Y. Also, the luminescent material can include additional elemental components, such as carbon, chlorine, hydrogen, and oxygen, that can be present in amounts that are less than about 5 percent in terms of elemental composition, and further elemental components, such as sodium, sulfur, phosphorus, and potassium, that can be present in trace amounts that are less than about 0.1 percent in terms of elemental composition.

Without wishing to be bound by a particular theory, it is believed that the luminescent material of formula (I) can be represented with reference to the formula:
[AₐB_{b}Xₓ][dopants] (II)

In formula (II), a is an integer that can be in the range of 1 to 9, such as from 1 to 5; b is an integer that can be in the range of 1 to 5, such as from 1 to 3; and x is an integer that can be in the range of 1 to 9, such as from 1 to 5. It is also contemplated that one or more of a, b, and x can have fractional values within their respective ranges. It is further contemplated that Xₓ in formula (II) can be more generally represented as XₓX′_{x′X″}_{x″}, where X, X′, and X″ can be independently selected from elements of Group VIIB, and the sum of x, x′, and x″ can be in the range of 1 to 9, such as from 1 to 5.

In the case that A is cesium, B is tin, and X is iodine, for example, it is believed that the luminescent material can be represented with reference to one of the formulas:
[CsSnI₃][dopants] (III)
[CsSn₂I₅][dopants] (IV)
[CsSn₃I₇][dopants] (V)
In the case of formula III, for example, the resulting luminescent material is believed to have a perovskite-based microstructure that is layered with relatively strong chemical bonding along a particular layer but relatively weak chemical bonding between different layers. This perovskite-based microstructure can undergo transitions between a variety of phases that have different colors.

In the case that A is cesium, B is indium, and X is iodine, for example, it is believed that the luminescent material can be represented with reference to the formula:
[CsInI][dopants] (VI)

In the case that A is cesium, B is germanium, and X is iodine, for example, it is believed that the luminescent material can be represented with reference to the formula:
[CsGeI₃][dopants] (VII)

In the case that A is rubidium, B is tin, and X is iodine, for example, it is believed that the luminescent material can be represented with reference to the formula:
[RbSnI₃][dopants] (VIII)

In the case that A is potassium, B is tin, and X is iodine, for example, it is believed that the luminescent material can be represented with reference to the formula:
[KSnI₃][dopants] (IX)

In the case that A is cesium, B is indium, and X is bromine, for example, it is believed that the luminescent material can be represented with reference to the formula:
[CsInBr][dopants] (X)

In the case that A is cesium, B is tin, and X is bromine, for example, it is believed that the luminescent material can be represented with reference to the formula:
[CsSnBr₃][dopants] (XI)

The dopants included in the luminescent material can be present in amounts that are less than about 5 percent in terms of elemental composition, and can derive from source (A) or other ingredients that are used to form the luminescent material. In the case that A is cesium, B is tin, and X is iodine, for example, it is believed that the dopants can include cations derived from or corresponding to tin (e.g., Sn(IV) or Sn⁺⁴ cations derived from oxidation of tin) and anions derived from or corresponding to Y (e.g., F⁻¹, Cl⁻¹, Br⁻¹, I⁻¹, or CH₃SO₃⁻¹ anions). The cations and anions can form electron acceptor/electron donor pairs that are dispersed within a microstructure of the luminescent material. Again, without wishing to be bound by a particular theory, it is believed that photoluminescent characteristics of the luminescent material can derive at least partly from the presence of these electron acceptor/electron donor pairs within that microstructure.

Other examples of luminescent materials include oxides, such as transition metal oxides, post-transition metal oxides, wide band gap semiconductor oxides, indirect band gap semiconductor oxides, and any other stable oxides; sulfides; and phosphates. The oxides, sulfides, and phosphates can include dopants selected from transition metals and rare earth elements that exhibit photoluminescence. Thus, for example, desirable luminescent materials can include zinc oxide (i.e., ZnO) doped with manganese (e.g., as Mn or having another suitable oxidation state), titanium oxide (i.e., TiO₂) doped with manganese (e.g., as Mn or having another suitable oxidation state), lanthanum phosphate (i.e., LaPO₄) doped with cerium (e.g., as Ce or having another suitable oxidation state) or another rare earth element, and silicon oxide (i.e., SiO₂) doped with a transition metal or a rare earth element. Table 1 below provides further examples of desirable luminescent materials along with their peak absorption wavelengths and peak emission wavelengths.

TABLE 1

| Photoluminescent | Peak Absorption | Peak Emission |
|---|---|---|
| Material | Wavelength | Wavelength |
| SrY₂O₄: Eu³⁺ | 250 nm | 611 nm |
| Bi₄Ge₃O₁₂ | 270 nm | 485 nm |
| Gd₃Ga₅O₁₂: Cr³⁺ | 365 nm | 730 nm |
| K₂La₂Ti₃O₁₀: Eu³⁺ | 365 nm | 594 nm |
| K₂La₂Ti₃O₁₀: Eu³⁺ | 365 nm | 617 nm |
| K₂La₂Ti₃O₁₀: Eu³⁺ | 365 nm | 702 nm |
| ZnGa₂O₄ | 250 nm | 460 nm |
| ZnGa₂O₄: Mn²⁺ | 270 nm | 505 nm |
| ZnO: Bi³⁺ | 430 nm | 645 nm |
| ZnO: Ga³⁺ | 250 nm | 388 nm |
| CaO: Zn²⁺ | 250 nm | 370 nm |
| CaO: Eu³⁺ | 410 nm | 600 nm |
| CaO: Tb³⁺ | 420 nm | 560 nm |
| Y₂O₂S: Er³⁺ | 980 nm | 548 nm |
| ZnO: S | 250 nm | 500 nm |
| ZnS: Mn²⁺ | 580 nm | 350 nm |
| ZnS: Eu²⁺ | 540 nm | 400 nm |

Further examples of luminescent materials include indirect band gap semiconductors, such as elements of Group IVB including silicon and germanium; semiconductors, such as InP and FeSi; organic dyes, such as phthalocyanines and porphorines; and metals, such as noble metals, gold, silver, copper, and other metals that have an absorption edge or a plasmon resonance in the ultraviolet range, the visible range, or the infrared range.

### Nanoparticles Formed of Luminescent Materials

Luminescent materials according to some embodiments of the invention can be formed as particles having a range of sizes, such as in the sub-nm range, the nm range, or the μm range. Alternatively, the luminescent materials can be formed in a bulk or pellet form and subsequently processed to form the particles. Methods for forming the particles include hydrothermal and chemical precipitation, sintering, and powdering, such as via ball milling, jar milling, or ultrasonic treatment. The resulting particles can be monodisperse or polydisperse with respect to their shapes and sizes. As further described below, each of the particles can include an outer layer, which can be formed using any suitable coating or encapsulation technique.

For certain anti-counterfeiting and inventory applications, particles having sizes in the nm range, such as the lower nm range, the middle nm range, or the upper nm range, can be used to form a coating, ink, or varnish composition. These nanoparticles can be monodisperse with respect to either of, or both, their shapes and sizes. Such characteristics of the nanoparticles can be desirable so as to facilitate incorporation of the nanoparticles in the composition, which, in turn, can be used to form markings for objects. In particular, such characteristics can allow adequate dispersion of the nanoparticles within the composition, and can allow the composition to be readily applied using a standard coating or printing technique. In addition, the presence of the nanoparticles in the resulting markings can be relatively unnoticeable, such that the markings can serve as covert markings for anti-counterfeiting applications.

In some instances, a nanoparticle can include a core formed of a luminescent material, and the core can be optionally surrounded by an outer layer. Depending on the specific application, the core can be formed of a single luminescent material or multiple luminescent materials that differ in some fashion. The core can have any of a variety of shapes, such as cylindrical, disk-shaped, spherical, spheroidal, or any other regular or irregular shape, and can have a range of sizes, such as in the lower nm range or the middle nm range.

The outer layer can provide environmental protection and isolation for the core, thereby providing improved stability to the core and retaining desirable photoluminescent characteristics for a prolonged period of time. The outer layer can also provide chemical compatibility with a solvent or a polymer binder when forming an ink composition, thereby improving dispersion of the nanoparticle in the resulting composition. The outer layer can be formed of any of a variety of inorganic and organic materials, such as intrinsic semiconductors; intrinsic insulators; oxides, such as silicon oxide, aluminum oxide, titanium oxide, and zirconium oxide; metals; metal alloys; and surface ligands. Thus, for example, the outer layer can be formed as a shell that surrounds the core. As another example, the outer layer can be formed as a ligand layer that surrounds the core. Depending on the specific application, the outer layer can be formed of a single material or multiple materials that differ in some fashion.

In some instances, the outer layer can be “complete,” such that the outer layer completely covers a surface of the core to cover all surface atoms of the core. Alternatively, the outer layer can be “incomplete,” such that the outer layer partially covers the surface of the core to partially cover the surface atoms of the core. The outer layer can have a range of thicknesses, such as in the sub-nm range, the lower nm range, or the middle nm range. The thickness of the outer layer can also be expressed in terms of a number of monolayers of a material forming the outer layer. Thus, for example, the thickness of the outer layer can be in the range of about 0 to about 20 monolayers, such as from about 1 to about 10 monolayers. A non-integer number of monolayers can correspond to a case in which the outer layer includes incomplete monolayers. Incomplete monolayers can be homogeneous or inhomogeneous, and can form islands or clumps on the surface of the core. Depending on the specific application, the outer layer can include multiple sub-layers that are formed of the same material or different materials in an onion-like configuration.

A practitioner of ordinary skill in the art requires no additional explanation in developing the apparatus, system, and method described herein but may nevertheless find some helpful guidance by examining the patent application of Midgley et al., U.S. Provisional Application Ser. No. 60/716,656, entitled “Authenticating and Identifying Objects Using Nanoparticles” and filed on Sep. 12, 2005; the patent application of Varadarajan et al., U.S. Provisional Application Ser. No. 60/784,863, entitled “Luminescent Materials that Emit Light in the Visible Range or the Near Infrared Range” and filed on Mar. 21, 2006; and the patent of Lee et al., U.S. Pat. No. 6,794,265, entitled “Methods of Forming Quantum Dots of Group IV Semiconductor Materials” and issued on Sep. 21, 2004; the disclosures of which are incorporated herein by reference in their entireties. A practitioner of ordinary skill in the art may also find some helpful guidance regarding luminescent materials by examining the following references: Yen et al., “Inorganic Phosphors: Compositions, Preparations and Optical Properties,” CRC Press, 2004; and “Phosphor Handbook,” ed. S. Shionoya and W. M. Yen, CRC Press, 1999; the disclosures of which are incorporated herein by reference in their entireties. A practitioner of ordinary skill in the art may further find some helpful guidance regarding detection and imaging techniques by examining the following articles: Cai et al., “Time-resolved Optical Diffusion Tomographic Image Reconstruction in Highly Scattering Turbid Media,” Proc. Natl. Acad. Sci., vol. 93, pp. 13561-13564, 1996; O'Leary et al., “Reradiation and Imaging of Diffuse Photon Density Waves Using Fluorescent Inhomogeneities,” Journal of Luminescence, vol. 60&61, pp. 281-286, 1994; Jiang et al., “Simultaneous Reconstruction of Optical Absorption and Scattering Maps in Turbid Media from Near-infrared Frequency-Domain Data,” Optics Letters, vol. 20, no. 20, pp. 2128-2130, 1995; Boas et al., “Scattering of Diffuse Photon Density Waves by Spherical Inhomogeneities Within Turbid Media: Analytical Solution and Applications,” Proc. Natl. Acad. Sci., vol. 91, pp. 4887-4891, 1994; Hayasaki et al., “Hiding an Image with a Light-Scattering Medium and Use of a Contrast-Discrimination Method for Readout,” Applied Optics, vol. 43, no. 7, pp. 1552-1558, 2004; Matson et al., “Imaging and Localization in Turbid Media,” Proceedings of SPIE, vol. 3866, pp. 74-81, 1999; Barun et al., “Nontraditional Features in Active Vision Through a Turbid Medium: Evaluation and Optimization on the Base of Modern Radiative Transfer Approaches,” Proceedings of SPIE, vol. 3837, pp. 414-425, 1999; and Qu et al., “Combination of Diffuse-Reflectance and Fluorescence Imaging of Turbid Media,” Proceedings of SPIE, vol. 3917, pp. 56-61, 2000; the disclosures of which are incorporated herein by reference in their entireties.

While the invention has been described with reference to the specific embodiments thereof it should be understood by those skilled in the art that various changes may be made and equivalents may be substituted without departing from the true spirit and scope of the invention as defined by the appended claims. In addition, many modifications may be made to adapt a particular situation, material, composition of matter, method, or process to the objective, spirit and scope of the invention. All such modifications are intended to be within the scope of the claims appended hereto. In particular, while the methods disclosed herein have been described with reference to particular operations performed in a particular order, it will be understood that these operations may be combined, sub-divided, or re-ordered to form an equivalent method without departing from the teachings of the invention. Accordingly, unless specifically indicated herein, the order and grouping of the operations are not limitations of the invention.

What is claimed is:

1. A container for an object, comprising:
a substrate having an outer surface and an inner surface and including a turbid material; and
a marking adjacent to the inner surface and including a luminescent material that exhibits photoluminescence in response to incident light directed on the outer surface, the photoluminescence having a quantum efficiency of at least 20 percent and a peak emission wavelength in the near infrared range.

2. The container of claim 1, wherein the substrate defines an internal compartment, and the inner surface faces the internal compartment.

3. The container of claim 2, wherein the internal compartment is sized to accommodate the object, and the marking is a security marking to authenticate the object.

4. The container of claim 1, wherein the marking includes a binder and a plurality of particles dispersed in the binder, the plurality of particles including the luminescent material.

5. The container of claim 4, wherein the plurality of particles have sizes in the nanometer range.

6. The container of claim 5, wherein the plurality of particles are monodisperse with respect to the sizes of the plurality of nanoparticles.

7. The container of claim 1, wherein the luminescent material has the formula:
[AₐB_{b}Xₓ],
wherein
A is selected from elements of Group IA;
B is selected from elements of Group VA, elements of Group IB, elements of Group IIB, elements of Group IIIB, elements of Group IVB, and elements of Group VB;
X is selected from elements of Group VIIB;
a is in the range of 1 to 5;
b is in the range of 1 to 3; and
x is in the range of 1 to 5.

8. The container of claim 7, wherein A is cesium, B is tin, and X is one of chlorine, bromine, and iodine.

9. The container of claim 7, wherein a is 1, b is 1, and x is 3.

10. The container of claim 7, wherein the luminescent material includes dopants.

11. The container of claim 10, wherein the dopants include electron acceptors and electron donors.

12. The container of claim 1, wherein the quantum efficiency is at least 30 percent.

13. The container of claim 1, wherein the photoluminescence has a spectral width that is no greater than 100 nm at Full Width at Half Maximum.

14. The container of claim 1, wherein the peak emission wavelength is in the range of 700 nm to 800 nm.

15. The container of claim 1, wherein the peak emission wavelength is in the range of 900 nm to 1 μm.

16. The container of claim 1, wherein the luminescent material produces emitted light in response to the incident light, and the container further comprises a reflective element adjacent to the marking to reflect at least a portion of the emitted light towards the outer surface.

17. A label for an object, comprising:
a substrate; and
a coating adjacent to the substrate and including a set of luminescent materials to provide an optical signature, at least one of the set of luminescent materials having the formula:
[AₐB_{b}Xₓ],
wherein
A is selected from elements of Group IA;
B is selected from elements of Group VA, elements of Group IB, elements of Group IIB, elements of Group IIIB, elements of Group IVB, and elements of Group VB;
X is selected from elements of Group VIIB;
a is in the range of 1 to 9;
b is in the range of 1 to 5; and
x is in the range of 1 to 9.

18. The label of claim 17, wherein the coating is adjacent to the object when the label is coupled to the object.

19. The label of claim 17, wherein the substrate includes a turbid material, and at least one of the set of luminescent materials exhibits photoluminescence in response to incident light directed through the turbid material.

20. The label of claim 19, wherein the photoluminescence has: (a) a quantum efficiency of at least 20 percent; (b) a spectral width no greater than 100 nm at Full Width at Half Maximum; and (c) a peak emission wavelength in the near infrared range.

21. The label of claim 19, wherein the set of luminescent materials includes: (a) a first luminescent material having a first peak emission wavelength; and (b) a second luminescent material having a second peak emission wavelength that is different from the first peak emission wavelength.

22. The label of claim 17, wherein the coating includes a plurality of nanoparticles including the set of luminescent materials.

23. The label of claim 17, wherein B is selected from elements of Group IVB.

24. The label of claim 17, wherein A is cesium, B is tin, and X is one of chlorine, bromine, and iodine.

25. The container of claim 17, wherein a is in the range of 1 to 5, b is in the range of 1 to 3, and x is in the range of 1 to 5.

26. The container of claim 25, wherein a is 1, b is 1, and x is 3.
